(19) United States
(12) Patent Application Publication
(10) Pub. No.: US 2021/0184238 A1
(43) Pub. Date: Jun. 17, 2021

(54) FUEL CELL SYSTEM FOR SUBMARINE USING SELECTIVE OXIDATION REACTION

(71) Applicant: BUMHAN FUEL CELL CO., LTD., Changwon-si, Gyeongsangnam-do (KR)

(72) Inventors: Hyunkhil SHIN, Changwon-si (KR); Kangsub AHN, Changwon-si (KR)

(73) Assignee: BUMHAN FUEL CELL CO., LTD., Changwon-si, Gyeongsangnam-do (KR)

(21) Appl. No.: 17/052,601

(22) PCT Filed: Apr. 30, 2019
(86) PCT No.: PCT/KR2019/005181

§ 371 Date: Nov. 3, 2020

(30) Foreign Application Priority Data
May 15, 2018 (KR) 10-2018-0055433

(51) Int. Cl. H01M 8/0668; H01M 8/04082; H01M 8/04089; H01M 8/04014; H01M 8/0662; H01M 8/0612

(52) U.S. Cl. CPC H01M 8/0668; H01M 8/04201; H01M 8/04097; H01M 2250/20; H01M 8/0681; H01M 8/0618; H01M 8/04022

(57) ABSTRACT

In a fuel cell system for a submarine, hydrogen gas having a reduced carbon monoxide content while the hydrogen gas passes through a purification unit using a selective oxidation reaction can be supplied as a raw material to a fuel cell, so that electrode activity deterioration which may be caused by carbon monoxide can be prevented. In addition, the fuel cell system for a submarine can be miniaturized and weight-reduced and allows gas unreacted in a fuel cell stack to be burnt and recycled to supply heat to a reforming unit, thereby minimizing the amount of discharge gas.

### TECHNICAL FIELD

The present invention relates to a fuel cell system for submarines. More specifically, the present invention relates to a fuel cell system for submarines, which comprises a purification unit using a preferential oxidation reaction.

### BACKGROUND ART

In general, a fuel cell is a power generation device that directly converts the chemical energy of hydrogen and oxygen in the air into electrical energy. Depending on the type of electrolyte used, fuel cells are categorized to alkaline fuel cells (AFC), phosphoric acid fuel cells (PAFC), molten carbonate fuel cells (MCFC), and polymer electrolyte membrane fuel cells (PEMFC).

The polymer electrolyte fuel cell (PEMFC) among the above is also called a proton exchange membrane fuel cell since it directly uses hydrogen gas as a fuel. It has advantages in that it can be operated at a relatively low temperature as compared with other fuel cells and that it is possible to reduce the size and weight of the device since the output density is large. However, in order to commercialize a polymer electrolyte fuel cell (PEMFC), a stable supply of hydrogen is the most important technical problem to be solved in advance.

As an alternative to this technical problem, a direct methanol fuel cell (DMFC) that directly uses methanol instead of hydrogen as a fuel is known (see Korean Laid-open Patent Publication No. 2007-0036502). In addition, as another alternative, it is possible to generate hydrogen gas through a reformer using ethanol, methanol, liquefied petroleum gas (LPG), gasoline, and the like for fuel cells. There is a problem that the gas generated through a reformer comprises carbon dioxide and carbon monoxide in addition to hydrogen.

Carbon monoxide among them is the main cause of deteriorating the electrode activity in the fuel cell. Thus, it is necessary to reduce the content of carbon monoxide in the hydrogen gas to about 10 ppm or less before being used as a fuel for fuel cells. In particular, since fuel cells do not need air for combustion, they are also mounted on submarines that must be operated secretly underwater. Fuel cells used in such submarines are required to further reduce the content of carbon monoxide in the hydrogen gas.

In addition, when fuel cells are used in submarines, a large amount of emissions can increase the possibilities that the submarines are detected, and additional power is required to increase the pressure of the exhaust gas according to the depth of the submarine in order to discharge gas from the submarines to the outside. Thus, it is necessary to minimize the amount of exhaust gas.

### DISCLOSURE OF INVENTION

### Technical Problem

Accordingly, an object of the present invention is to provide a fuel cell system for submarines, whose size and weight can be reduced, while supplying hydrogen gas with a low content of carbon monoxide as a raw material and minimizing the amount of exhaust gas.

### Solution to Problem

According to the above object, there is provided a fuel cell system for submarines, which comprises a hydrogen supply unit to supply hydrogen gas; an oxygen storage unit to supply oxygen gas; a fuel cell unit comprising a fuel cell stack, and connected to the hydrogen supply unit and to the oxygen storage unit to receive hydrogen gas and oxygen gas to generate electric energy; and a purification unit positioned between the hydrogen supply unit and the fuel cell unit to purify the hydrogen gas supplied from the hydrogen supply unit and then discharge it to the fuel cell unit, wherein the purification unit comprises a first purification unit to reduce carbon monoxide in the hydrogen gas supplied from the hydrogen supply unit by a preferential oxidation reaction.

### Advantageous Effects of Invention

In the fuel cell system for submarines according to the present invention, hydrogen gas having a lower content of carbon monoxide can be supplied to the fuel cells as a raw material while the hydrogen gas passes through the purification unit, so that a decrease in the electrode activity due to carbon monoxide can be prevented. In addition, the fuel cell system for submarines has a reforming unit that uses methanol and water as a raw material, which enables miniaturization and weight reduction, and unreacted gas in the fuel cell stack is combusted and is recycled to supply heat to the reforming unit, whereby the amount of exhaust gas can be minimized.

### BRIEF DESCRIPTION OF DRAWINGS

FIG. 1 schematically shows the configuration of a fuel cell system for submarines according to an embodiment of the present invention.

FIGS. 2a and 2b schematically show the configuration and operation principle of a multi-stage fuel cell stack.

### EXPLANATION OF REFERENCE NUMERALS

100: hydrogen supply unit

110: water storage unit

120: methanol storage unit

150: reforming unit

200: oxygen storage unit

300: purification unit

310: first purification unit

400: heat supply unit

500: fuel cell unit

510: fuel cell stack

511: first fuel cell stack

512: second fuel cell stack

513: third fuel cell stack

### BEST MODE FOR CARRYING OUT THE INVENTION

Hereinafter, the constitution and function according to an embodiment of the present invention will be described in detail with reference to the accompanying drawings. The following description is one of the several aspects of the invention that can be claimed, and the following description may form part of the detailed techniques of the invention.

In describing the present invention, however, detailed descriptions of known constitution and function may be omitted to clarify the present invention.

Since the present invention may be modified in various ways and may include various embodiments, specific embodiments will be illustrated in the drawings and described in the detailed description. However, this is not intended to limit the present invention to a specific embodiment. Rather, it is to be understood to cover all changes, equivalents, or substitutes encompassed in the ideal and scope of the present invention.

Terms including ordinal numbers, such as first and second, may be used to describe various elements, but the corresponding elements are not limited by these terms. These terms are only used for the purpose of distinguishing one element from another.

When an element is referred to as being “connected” to another element, it is to be understood that although it may be directly connected to the other component, another component may be interposed between them.

In addition, when an element is referred to as “supplying” a specific substance to another element, it is to be understood that a supply line capable of supplying the substance to the other component is provided and the substance is supplied through the supply line.

The terms used in the present application are used only to describe specific embodiments and are not intended to limit the present invention. Singular expressions include plural expressions unless the context clearly indicates otherwise.

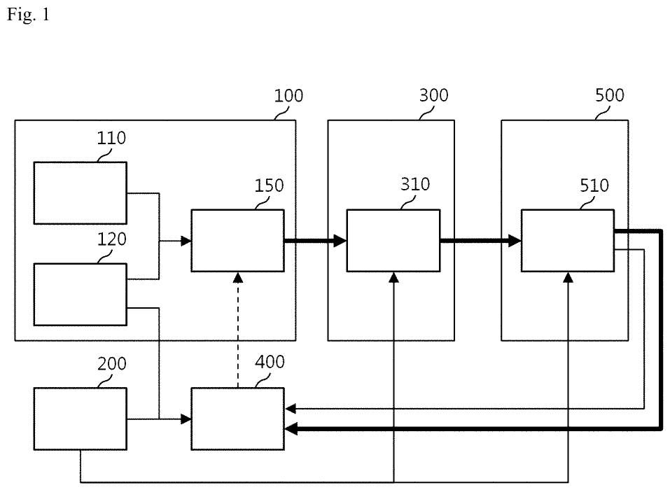

FIG. 1 schematically shows the configuration of a fuel cell system for submarines according to an embodiment of the present invention (in FIG. 1, a square represents each element, a solid arrow represents a flow of raw material, in particular, a thick solid arrow represents a flow of hydrogen gas, and a dotted arrow represents a flow of heat).

Referring to FIG. 1, the fuel cell system for submarines according to an embodiment of the present invention comprises a hydrogen supply unit (100) to supply hydrogen gas; an oxygen storage unit (200) to supply oxygen gas; a fuel cell unit (500) comprising a fuel cell stack (510), and connected to the hydrogen supply unit (100) and to the oxygen storage unit (200) to receive hydrogen gas and oxygen gas to generate electric energy; and a purification unit (300) positioned between the hydrogen supply unit (100) and the fuel cell unit (500) to purify the hydrogen gas supplied from the hydrogen supply unit (100) and then discharge it to the fuel cell unit (500), wherein the purification unit (300) comprises a first purification unit (310) to reduce carbon monoxide in the hydrogen gas supplied from the hydrogen supply unit (100) by a preferential oxidation reaction.

Hydrogen Supply Unit

The hydrogen supply unit (100) may comprise a water storage unit (110) to supply water; a methanol storage unit (120) to supply methanol; and a reforming unit (150) connected to the water storage unit (110) and to the methanol storage unit (120) to generate hydrogen gas reformed from water and methanol.

The reforming unit (150) heats the water supplied from the water storage unit (110) and the methanol supplied from the methanol storage unit (120) to approximately 250 to 300° C. to vaporize them. Then, the vaporized methanol and water vapor are subjected to a catalytic reaction to produce a reformed gas in which H₂, CO, CO₂, and the like are mixed. In addition, if necessary, a water-gas shift reactor may be provided to engage in the gas production.

Specifically, in the reforming unit (150), methanol is converted to hydrogen, carbon monoxide, formaldehyde, or methyl formate on the catalyst. A reforming reaction is carried out in the presence of water for the conversion to hydrogen and carbon monoxide or carbon dioxide (see the following reaction schemes).

CH₃OH→HCHO+H₂

HCHO+CH₃OH→H₂(OH)OCH₃→HCOOCH₃+H₂

HCOOCH₃→CO+CH₃OH (or CO₂+CH₄)

As illustrated above, the gas finally discharged from the hydrogen supply unit (100) through the reaction in the reforming unit (150) contains other types of gases than hydrogen. Thus, it is necessary to increase the purity of the hydrogen gas and to lower the content of other types of gas in the subsequent purification unit (300).

In particular, carbon monoxide contained in the hydrogen gas is the main cause of deteriorating the electrode activity in the fuel cells. Thus, it is necessary to reduce its content in the subsequent purification unit (300).

Purification Unit

The purification unit (300) is positioned between the hydrogen supply unit (100) and the fuel cell unit (500) and purifies the hydrogen gas supplied from the hydrogen supply unit (100) to discharge it to the fuel cell unit (500).

The purification unit (300) comprises a first purification unit (310) to reduce carbon monoxide in the hydrogen gas supplied from the hydrogen supply unit (100) by a preferential oxidation (selective oxidation) reaction.

In the first purification unit (310) for the preferential oxidation reaction, oxygen is mixed with the supplied gas, and carbon monoxide is then removed from the hydrogen gas using a catalyst having high carbon monoxide selectivity (see the following reaction scheme).

CO+½O₂→CO₂

In such event, a platinum catalyst may be used as a catalyst for the preferential oxidation reaction. In order to enhance the selectivity of the reaction and the reaction rate, it is preferable to maintain the reaction temperature in the range of 130 to 250° C.

In addition, since the preferential oxidation reaction requires an excess of oxygen, it is preferable that the oxygen storage unit (200) is additionally connected to the first purification unit (310) to supply oxygen gas to the first purification unit (310).

The hydrogen gas finally discharged from the purification unit (300) through the first purification unit (310) may have a very low content of carbon monoxide and a high purity. For example, the hydrogen gas discharged from the purification unit (300) may have a content of carbon monoxide of 10 ppm or less. More specifically, the hydrogen gas discharged from the purification unit may have a content of carbon monoxide of 1 ppm or less.

Fuel Cell Unit

The fuel cell unit (500) comprises a fuel cell stack (510) and is connected to the hydrogen supply unit (100) and to the oxygen storage unit (200) to receive hydrogen gas and oxygen gas to generate electric energy.

The fuel cell stack may be a stack of polymer electrolyte fuel cells (PEMFC).

For example, the fuel cell stack may have a structure in which a plurality of fuel cells are stacked. Each fuel cell comprises an anode electrode, a cathode electrode opposed to the anode electrode, and an electrolyte membrane interposed between the anode electrode and the cathode electrode.

Specifically, the anode electrode may use hydrogen supplied from the hydrogen supply unit (100), and the cathode electrode may use oxygen supplied from the oxygen storage unit (200). In such event, an oxidation reaction as shown in the following Reaction Scheme (1) is carried out in the anode electrode, and a reduction reaction as shown in the following Reaction Scheme (2) is carried out in the cathode electrode. The net reaction of the fuel cell unit (500) is as shown in the following Reaction Scheme (3).

H₂→2H++2e⁻ (1)

½O₂+2H++2e⁻→H₂O (2)

H₂+½O₂→H₂O (3)

As an example, the fuel cell stack (510) may be a single-stage fuel cell stack.

If 100% of hydrogen gas and oxygen gas are initially supplied, about 10 to 20% of hydrogen gas and oxygen gas relative to the initial state may be unused and discharged upon the generation of electric energy in the fuel cell stack. Such unused gas is not desirable in a closed space such as a submarine since it requires a separate process for discharging it. Accordingly, the present invention can minimize the amount of exhaust gas even when a single-stage fuel cell stack is used by recycling the unused gas from the fuel cell stack to the heat supply unit (400). Alternatively, the amount of exhaust gas may be minimized by the incineration of the unused gas in the fuel cell stack (510).

As another example, the fuel cell stack (510) may be a multi-stage fuel cell stack. Such a multi-stage fuel cell stack is suitable for a closed space such as a submarine since the amount of gas finally discharged is minimized.

Preferably, the fuel cell stack (510) may be a fuel cell stack composed of 2 to 10 stages and may discharge unused hydrogen gas in an amount of 0.5% or less relative to the supplied hydrogen gas.

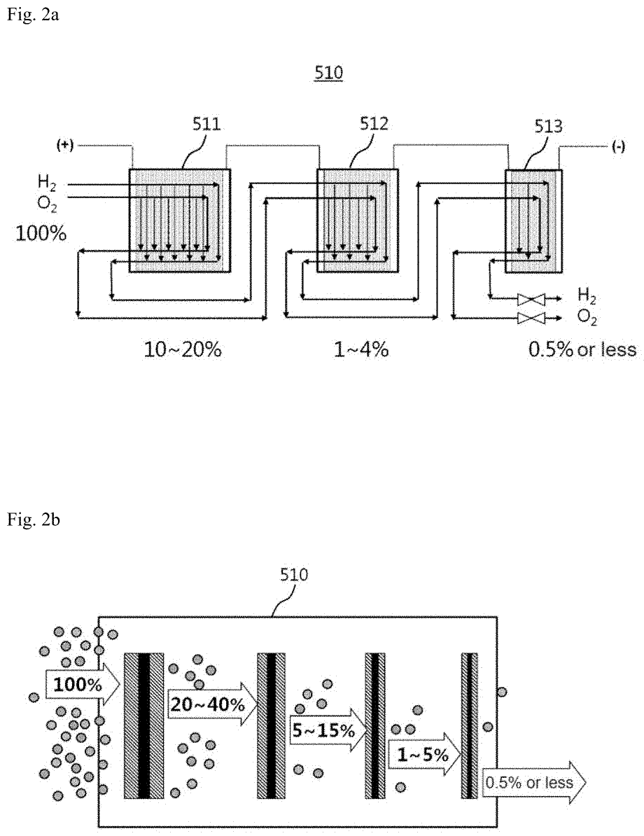

FIGS. 2a and 2b schematically show the configuration and operation principle of a multi-stage fuel cell stack.

Referring to FIG. 2a, according to a specific example, the multi-stage fuel cell stack may be one in which a plurality of fuel cell stacks (511, 512, and 513) are connected in series to improve the consumption rate. In such event, 100% of fuel (hydrogen gas and oxygen gas) is initially supplied to the first fuel cell stack (511) to generate electric energy, and 10 to 20% of unused fuel is then discharged. The unused fuel is supplied to the second fuel cell stack (512) to generate electric energy, and 1 to 4% of the unused fuel relative to that initially supplied is then discharged. The unused fuel is supplied to the third fuel cell stack (513) to generate electric energy, and less than 0.5% of the unused fuel relative to that initially supplied may then be discharged.

Referring to FIG. 2b, according to another specific example, the multi-stage fuel cell stack may be one in which a reaction of several stages is carried out within one fuel cell stack to improve the consumption rate. In such event, 100% of fuel (hydrogen gas and oxygen gas) is initially supplied to the multi-stage fuel cell stack, electric energy is generated in the first stage, and 20 to 40% of unused fuel relative to that initially supplied is then discharged; electric energy is generated in the second stage, and 5 to 15% of unused fuel relative to that initially supplied is then discharged; electric energy is generated in the third stage, and 1 to 5% of unused fuel relative to that initially supplied is then discharged; and electric energy is generated in the fourth stage, and 0.5% or less of unused fuel relative to that initially supplied may then be discharged.

Oxygen Storage Unit

The oxygen storage unit (200) stores oxygen therein to be supplied to the cathode (or oxygen electrode) of the fuel cell stack (510) and the like.

The oxygen storage unit (200) may comprise a tank for storing liquid oxygen. In normal conditions, oxygen in the atmosphere can be used as an oxygen source of a fuel cell. However, liquid oxygen is preferably used in closed conditions such as a submarine since the atmosphere is not available.

Heat Supply Unit

In addition, the fuel cell system for submarines may further comprise a heat supply unit (400), which is connected to the methanol storage unit (120) and to the oxygen storage unit (200) and burns methanol and oxygen gas to supply heat to the reforming unit (150).

In addition, the heat supply unit (400) and the fuel cell unit (500) are connected to each other, so that the gas unused in the fuel cell unit (500) may be recycled to the heat supply unit (400). Specifically, since the gas unused in the fuel cell unit (500) comprises hydrogen gas and oxygen gas, it is burned in the heat supply unit (400) to supply heat to the reforming unit (150). As a result, it is possible to further reduce the amount of gas finally discharged from the fuel cell system.

The heat supply unit (400) may comprise a burner and a heat exchanger. As an example, the gases supplied to the heat supply unit (400) are burned in the burner, and heat may then be supplied to the reforming unit (150) through the heat exchanger.

As another example, a combustion burner may be installed around the reforming unit (150), so that the combustion heat may be directly supplied to the reforming unit (150). Since this type does not require a heat exchanger, it has an advantage in that the size may be reduced.

Incineration Unit

In addition, the fuel cell system may further comprise an incineration unit (not shown) connected to the fuel cell unit (500). The incineration unit may incinerate unused gas, specifically unused hydrogen gas and oxygen gas, discharged from the fuel cell unit (500).

As a result, it is possible to further reduce the amount of gas finally discharged from the fuel cell system.

Control Unit

In addition, the fuel cell system may further comprise a control unit (not shown) for controlling at least one of the hydrogen supply unit (100), the oxygen storage unit (200), the purification unit (300), the heat supply unit (400), and the fuel cell unit (500).

The control unit may be composed of, for example, a small built-in computer and may be provided with a data processing unit composed of a program, a memory, a CPU, and the like.

The program of the control unit may comprise an algorithm for controlling the operation of the hydrogen supply unit (100), the oxygen storage unit (200), the purification unit (300), the heat supply unit (400), and the fuel cell unit (500) based on the data measured or analyzed from them. Such a program may be saved in a memory unit such as a computer storage medium, such as a flexible disk, a compact disk, a hard disk, or a magneto-optical (MO) disk to be installed in the control unit.

Effects and Uses

The fuel cell system for submarines according to the embodiments of the present invention as described above, hydrogen gas having a lower content of carbon monoxide can be supplied to the fuel cells as a raw material while the hydrogen gas passes through the purification unit, so that a decrease in the electrode activity due to carbon monoxide can be prevented. In addition, the fuel cell system for submarines has a reforming unit that uses methanol and water as a raw material, which enables miniaturization and weight reduction, and the amount of unreacted gas is minimized in the fuel cell stack. Thus, it can be advantageously used as a fuel cell system for supplying power in a closed condition such as a submarine.

The embodiments of the present invention have been described with reference to the accompanying drawings. However, those of ordinary skill in the art to which the present invention pertains can understand that the present invention can be implemented in other specific forms without changing the technical idea or essential features thereof. For example, those skilled in the art may change the material, size, and the like of each element according to the field of application, or combine or substitute the embodiments to implement in a form that is not clearly disclosed in the descriptions of the present invention, which does not fall outside the scope of the present invention. Therefore, the embodiments described above are illustrative in all respects and should not be understood as limiting the subject invention. These modified embodiments fall under the technical idea described in the claims of the present invention.

1. A fuel cell system for submarines, which comprises:
a hydrogen supply unit to supply hydrogen gas;
an oxygen storage unit to supply oxygen gas;
a fuel cell unit comprising a fuel cell stack, and connected to the hydrogen supply unit and to the oxygen storage unit to receive the hydrogen gas and the oxygen gas to generate electric energy; and
a purification unit positioned between the hydrogen supply unit and the fuel cell unit to purify the hydrogen gas supplied from the hydrogen supply unit and then discharge it to the fuel cell unit,
wherein the purification unit comprises a first purification unit to reduce carbon monoxide in the hydrogen gas supplied from the hydrogen supply unit by a preferential oxidation reaction.

2. The fuel cell system for submarines of claim 1, wherein the hydrogen gas discharged from the purification unit has a content of carbon monoxide of 10 ppm or less.

3. The fuel cell system for submarines of claim 1, wherein the fuel cell stack is a single-stage or multi-stage fuel cell stack.

4. The fuel cell system for submarines of claim 1, wherein the fuel cell stack is a stack of polymer electrolyte fuel cells (PEMFC).

5. The fuel cell system for submarines of claim 1, wherein the oxygen storage unit is additionally connected to the first purification unit to supply oxygen gas to the first purification unit.

6. The fuel cell system for submarines of claim 1, wherein the hydrogen supply unit comprises:
a water storage unit to supply water;
a methanol storage unit to supply methanol; and
a reforming unit connected to the water storage unit and to the methanol storage unit to generate hydrogen gas reformed from water and methanol.

7. The fuel cell system for submarines of claim 6, which further comprises a heat supply unit, which is connected to the methanol storage unit and to the oxygen storage unit and burns methanol and oxygen gas to supply heat to the reforming unit.

8. The fuel cell system for submarines of claim 7, wherein the heat supply unit and the fuel cell unit are connected to each other, so that gas unused in the fuel cell unit is recycled to the heat supply unit.

9. The fuel cell system for submarines of claim 8, wherein the gas unused in the fuel cell unit comprises hydrogen gas and oxygen gas.

10. The fuel cell system for submarines of claim 1, which further comprises an incineration unit connected to the fuel cell unit, wherein the incineration unit incinerates gas unused in the fuel cell unit.
